(19) United States
(12) Patent Application Publication
(10) Pub. No.: US 2024/0379955 A1
(43) Pub. Date: Nov. 14, 2024

(54) POSITIVE ELECTRODE FOR NON-AQUEOUS ELECTROLYTE, RECHARGEABLE BATTERY, AND NON-AQUEOUS ELECTROLYTE RECHARGEABLE BATTERY

(71) Applicant: SAMSUNG SDI CO. LTD., Gyeonggi-do (KR)

(72) Inventors: Jinseok BAEK, Gyeonggi-do (KR); Kunihiro INUI, Gyeonggi-do (KR); Takayoshi FUJITA, Gyeonggi-do (KR)

(73) Assignee: SAMSUNG SDI CO., LTD., Gyeonggi-do (KR)

(21) Appl. No.: 18/661,024

(22) Filed: May 10, 2024

(30) Foreign Application Priority Data
May 11, 2023 (JP) 2023-189568
May 9, 2024 (KR) 10-2024-0061500

(51) Int. Cl. H01M 4/525; H01M 4/02; H01M 4/131; H01M 4/62

(52) U.S. Cl. CPC H01M 4/525; H01M 4/131; H01M 4/625; H01M 2004/021; H01M 2004/028

(57) ABSTRACT

Example embodiments include a positive electrode for a non-aqueous electrolyte rechargeable battery that is capable of sufficiently reducing an increase in the internal temperature of the battery, improving safety, and maintaining electrical resistance and cycle characteristics within an appropriate range. According to example embodiments, a positive electrode for a non-aqueous electrolyte rechargeable battery includes a positive electrode active material and inorganic particles, the inorganic particles contain boron, D₅₀, 50% of an integrated value of a particle diameter volume-based particle size distribution in a particle size distribution obtained by a laser diffraction/scattering method of the inorganic particles is greater than or equal to about 0.3 μm and less than or equal to about 8.0 μm, and a ratio of a major diameter to a minor diameter of the inorganic particles is greater than or equal to about 3.0 and less than or equal to about 30.

### CROSS-REFERENCE TO RELATED APPLICATION

This application claims priority to and the benefit of Japanese Patent Application No. 2023-189568 filed in the Japan Patent Office on May 11, 2023, and Korean Patent Application No. 10-2024-0061500 filed in the Korean Intellectual Property Office on May 9, 2024, the entire contents of each of the above priority applications are incorporated herein by reference.

### BACKGROUND OF THE INVENTION

### (a) Field of the Invention

Example embodiments relate to a positive electrode for a non-aqueous electrolyte rechargeable battery and a non-aqueous electrolyte rechargeable battery including the positive electrode.

### (b) Description of the Related Art

Non-aqueous electrolyte rechargeable batteries including rechargeable lithium ion batteries are widely used as power sources for, e.g., smart phones, notebook computers, and the like, as well as for large-sized batteries such as, e.g., batteries for vehicles.

Rechargeable lithium ion batteries have advantages of high energy density, and because rechargeable lithium ion batteries use non-aqueous electrolytes, sufficient measures may be desired to be taken for safety. Also, with the increase in the size of the batteries, ensuring safety provides substantial advantages.

For example, when a rechargeable lithium ion battery is placed in a high-temperature environment, the positive electrode of the rechargeable lithium ion battery may generate heat, or heat may be generated due to an oxidative decomposition reaction of the electrolyte caused by oxygen radicals generated from the positive electrode, possibly causing an increase in the internal temperature of the battery.

When the internal temperature of the battery becomes high due to such or other causes, a short circuit due to shrinkage of the separator provided in the rechargeable lithium ion battery may occur, and there is a risk that the internal temperature of the battery may gradually rise.

Therefore, in order to reduce or suppress an increase in the internal temperature of the rechargeable lithium ion battery and ensure safety thereof, the addition of boron nitride as heat-conducting particles to the positive electrode (Patent Document; Japanese Patent Application Publication No. 2014-191912) has been proposed.

### SUMMARY OF THE INVENTION

In some instances, the internal temperature of the battery may not be sufficiently reduced or suppressed simply by including boron nitride in the positive electrode. Additionally, when boron nitride is included in the positive electrode, the battery resistance of the battery may increase, or the cycle characteristics may deteriorate.

Example embodiments include a positive electrode for a non-aqueous electrolyte rechargeable battery that can sufficiently reduce or suppress an increase in the internal temperature of the battery, improve safety, and maintain electrical resistance and cycle characteristics within an appropriate range.

That is, the present disclosure includes the following. A positive electrode for a non-aqueous electrolyte rechargeable battery includes a positive electrode active material and inorganic particles, wherein the inorganic particles contain boron, D₅₀ of the inorganic particles may be greater than or equal to about 0.3 μm and less than or equal to about 8.0 μm, and a ratio (major/minor diameter) of a major diameter to a minor diameter of the inorganic particles may be greater than or equal to about 3.0 and less than or equal to about 30. A ratio B/A of D₅₀ (A) of the positive electrode active material and D₅₀ (B) of the inorganic particles may be greater than or equal to about 0.010 and less than or equal to about 0.8. The inorganic particle may be or include boron nitride (BN). A Brunauer, Emmett and Teller (BET) specific surface area of the inorganic particles calculated by the adsorption isotherm measured by adsorbing nitrogen to the inorganic particles may be greater than or equal to about 1 m²/g and less than or equal to about 50 m²/g. The positive electrode for a non-aqueous electrolyte rechargeable battery may include a positive electrode current collector and a positive electrode mixture layer on the positive electrode current collector, wherein the inorganic particles are included in the positive electrode mixture layer, and a content of the inorganic particles based on 100 wt % of the positive electrode mixture layer may be in a range of greater than or equal to about 0.1 wt % and less than or equal to about 5.0 wt %.

The positive electrode for a non-aqueous electrolyte rechargeable battery includes a positive electrode current collector, a positive electrode mixture layer on the positive electrode current collector, and a temperature increase suppression layer on a side of the positive electrode mixture layer opposite to the current collector, wherein the inorganic particles are included in the temperature increase suppression layer, and a content of the inorganic particles based on 100 wt % of the temperature increase suppression layer is in a range of greater than or equal to about 40 wt % and less than or equal to about 99 wt %.

A content of a binder based on 100 wt % of the temperature increase suppression layer may be greater than or equal to about 1 wt % and less than or equal to about 60 wt %.

The temperature increase suppression layer may have a thickness greater than or equal to about 0.1 μm and less than or equal to about 5 μm.

A non-aqueous electrolyte rechargeable battery according to some example embodiments includes a positive electrode, a negative electrode, a separator, and a non-aqueous electrolyte, wherein the positive electrode is the aforementioned positive electrode.

According to some example embodiments, because the D₅₀ and major/minor diameter of the boron-containing inorganic particles contained in the positive electrode are within a predetermined or desired range, when the temperature inside the battery begins to rise, an endothermic reaction occurs in the inorganic particles, resulting in reducing or suppressing an electrolyte decomposition reaction. Thereby, an increase in internal temperature of the non-aqueous electrolyte rechargeable battery may be sufficiently reduced or suppressed, safety may be improved, and improved electrical resistance and cycle characteristics of the non-aqueous electrolyte rechargeable battery may be maintained.

### BRIEF DESCRIPTION OF THE DRAWINGS

FIG. 1 is a schematic view showing the overall structure of a non-aqueous electrolyte rechargeable battery according to some example embodiments.

FIG. 2 is a schematic view showing the overall structure of a non-aqueous electrolyte rechargeable according to some example embodiments.

FIG. 3 is a graph showing the discharge capacity retention rates of the rechargeable battery cells according to Example 1 and Comparative Example 1.

FIG. 4 is a graph showing cell resistance of the rechargeable battery cells according to Example 1 and Comparative Example 1.

FIG. 5 is a graph showing the intensity of oxygen released from the positive electrodes when the temperature is increased in the rechargeable battery cells according to Example 1 and Comparative Example 1.

### DETAILED DESCRIPTION OF EXAMPLE EMBODIMENTS

Hereinafter, example embodiments will be described in detail so that those of ordinary skill in the art can easily implement them. However, this disclosure may be embodied in many different forms and is not construed as limited to the example embodiments set forth herein.

The terminology used herein is used to describe example embodiments, and is not intended to limit the present disclosure.

The singular expression includes the plural expression unless the context clearly dictates otherwise.

As used herein, “combination thereof” indicates a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof. In the drawings, the thickness of layers, films, panels, regions, etc., are exaggerated for clarity and like reference numerals designate like elements throughout the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the particle diameter may be an average particle diameter and the average particle diameter may be measured by a method known to those skilled in the art, for example, may be measured by a particle size analyzer, or may be measured by, e.g., a transmission electron microscopic image or a scanning electron microscopic image.

Alternatively, it is possible to obtain an average particle diameter value by measuring using a dynamic light scattering method, performing data analysis, counting the number of particles for each particle size range, and calculating from this. Unless otherwise defined, the average particle diameter may indicate the diameter (D₅₀) of particles having a cumulative volume of 50 volume % in the particle size distribution. As used herein, when a definition is not otherwise provided, the average particle diameter indicates a diameter (D₅₀) of particles having a cumulative volume of 50 volume % in the particle size distribution that is obtained by measuring the size (diameter or length of the long axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

Hereinafter, a configuration of a non-aqueous electrolyte rechargeable battery according to some example embodiments will be described.

### 1. Basic Configuration of Non-Aqueous Electrolyte Rechargeable Battery

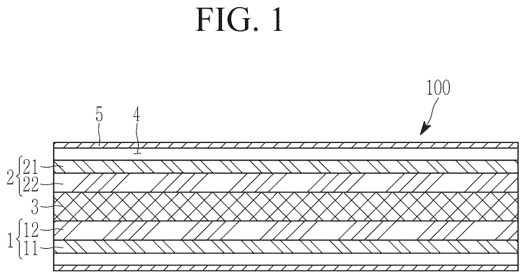

As shown in FIG. 1, the non-aqueous electrolyte rechargeable battery 100 according to an example embodiment is a lithium ion secondary battery including a positive electrode 1, a negative electrode 2, a separator 3 therebetween, a non-aqueous electrolyte solution 4, and a case 5 that accommodates the above features therein. FIG. 1 is a cross-sectional schematic view showing a cross section of the non-aqueous electrolyte rechargeable battery 100.

The shape of the rechargeable lithium ion battery 100 may be, for example, cylindrical, square, laminate, or button.

### 1-1. Positive Electrode

In various examples, the positive electrode 1 includes a positive electrode current collector 11 and a positive electrode mixture layer 12 on the positive electrode current collector 11.

The positive electrode current collector 11 may be or include any material as long as the material is a conductor, and is, for example, plate-shaped or thin, and may be made of at least one of aluminum, stainless steel, nickel coated steel, and the like.

The positive electrode mixture layer 12 may include at least a positive electrode active material, and may further include a conductive agent and a positive electrode binder.

The positive electrode active material may be or include, for example, a transition metal oxide or a solid solution oxide including lithium, as long as the positive electrode active material is or includes a material that can electrochemically intercalate and deintercalate lithium ions. The shape of the positive electrode active material may be in the form of, e.g., particles.

Examples of the transition metal oxide including lithium may include Li_{1.0}Ni_{0.88}Co_{0.1}Al_{0.01}Mg_{0.01}O₂, and the like. In addition, Li—Co composite oxides such as, e.g., LiCoO₂, and Li—Ni—Co—Mn-based composite oxides such as, e.g., LiNiₓCo_{y}Mn_{z}O₂, Li—Ni-based composite oxide such as, e.g., LiNiO₂, or Li—Mn-based composite oxides such as, e.g., LiMn₂O₄, and the like. Examples of the solid solution oxide may include at least LiₐMnₓCo_{y}Ni_{z}O₂ (1.150≤a≤1.430, 0.45≤x≤0.6, 0.10≤y≤0.15, 0.20≤z≤0.28), or LiMn_{1.5}Ni_{0.5}O₄. A content (content ratio) of the positive electrode active material is not particularly limited, as long as the content or content ratio is applicable to the positive electrode mixture layer 12 of the non-aqueous electrolyte rechargeable battery 100. Moreover, these compounds may be used alone or may be used in various mixture.

A material of the conductive agent is not particularly limited as long as the conductive agent increases the conductivity of the positive electrode 1. Examples of the conductive agent may include at least one of, e.g., carbon black, natural graphite, artificial graphite, fibrous carbon, and sheet-like carbon.

Examples of the carbon black may include, e.g., furnace black, channel black, thermal black, ketjen black, and acetylene black.

Examples of the fibrous carbon may include carbon nanotubes and carbon nanofibers, and examples of the sheet-like carbon include graphene and the like.

A content of the conductive agent in the positive electrode mixture layer 12 may be, e.g., greater than or equal to about 0.1 wt % and less than or equal to about 5 wt %, or greater than or equal to about 0.5 wt % and less than or equal to about 3 wt % based on the total amount of the positive electrode mixture layer 12, in order to achieve both conductivity and battery capacity.

The positive electrode binder may include, for example, a fluoro-containing resin such as, e.g., polyvinylidene fluoride, an ethylene-containing resin such as, e.g., at least one of styrene-butadiene rubber, an ethylene-propylene diene terpolymer, an acrylonitrile-butadiene rubber, a fluoro rubber, polyvinyl acetate, polymethylmethacrylate, polyethylene, polyvinyl alcohol, carboxymethyl cellulose, a carboxymethyl cellulose derivative (a salt of carboxymethyl cellulose, etc.), nitrocellulose, and the like. The positive electrode binder may be or include any material capable of binding the positive electrode active material and the conductive agent onto the positive electrode current collector 11.

### 1-2. Negative Electrode

In various examples, the negative electrode 2 includes a negative current collector 21 and a negative electrode mixture layer 22 on the negative current collector 21. The negative current collector 21 may be any conductor material, and may be plate-shaped or thin, and made of or include copper, stainless steel, nickel-plated steel, or the like.

The negative electrode mixture layer 22 may include a negative electrode active material, and may further include a conductive agent and a negative electrode binder.

The negative electrode active material is configured to electrochemically intercalate and deintercalate lithium ions, and may be or include at least one of, for example, a graphite active material (artificial graphite, natural graphite, a mixture of artificial graphite and natural graphite, natural graphite coated with artificial graphite), a Si-based active material, or a Sn-based active material (e.g., a mixture of fine particles of silicon (Si) or tin (Sn) or a mixture of oxides thereof and a graphite active material, particulates of silicon or tin, an alloy including silicon or tin as a base material), metallic lithium, and a titanium oxide compound such as Li₄Ti₅O₁₂, lithium nitride, and the like. As the negative electrode active material, one of the above examples may be used, or two or more types may be used in combination. On the other hand, oxides of silicon may be represented by SiOₓ (0<x≤2).

A material of the conductive agent is configured to increase the conductivity of the negative electrode 2, and may be or include for example, the same conductive agent as described in the section of the positive electrode 1 may be used.

A content of the conductive agent in the negative electrode mixture layer 22 may be greater than or equal to about 0.1 wt % and less than or equal to about 5 wt %, or greater than or equal to about 0.5 wt % and less than or equal to about 3 wt % based on the total weight of the negative electrode mixture layer 22, from the viewpoint of achieving both conductivity and battery capacity.

The negative electrode binder may be capable of binding the negative electrode active material and the conductive agent on the negative current collector 21. The negative electrode binder may be or include, for example, polyvinylidene fluoride (PVDF), polytetrafluoroethylene (PTFE), polyacrylic acid (PAA), a styrene-butadiene-based copolymer (SBR), a metal salt of carboxymethyl cellulose (CMC), etc. The binder may be used alone or may be used in mixture of two or more types.

### 1-3. Separator

The separator 3 may be, e.g., any separator that can be used in a rechargeable lithium ion battery. The separator 3 may be or include a porous film, a nonwoven fabric, or the like that exhibits a desired, improved or advantageous high-rate discharge performance alone or in combination. The resin constituting or included in the separator 3 may be or include, for example, a polyolefin-based resin such as polyethylene, polypropylene, etc., a polyester resin such as polyethylene terephthalate, polybutylene terephthalate, etc., polyvinylidene difluoride, a vinylidene difluoride-hexafluoropropylene copolymer, a vinylidene difluoride-perfluorovinyl ether copolymer, a vinylidene difluoride-tetrafluoroethylene copolymer, a vinylidene difluoride-trifluoroethylene copolymer, a vinylidene difluoride-hexafluoroacetone copolymer, a vinylidene difluoride-ethylene copolymer, a vinylidene difluoride-propylene copolymer, a vinylidene difluoride-trifluoro propylene copolymer, a vinylidene difluoride-tetrafluoroethylene copolymer, a vinylidene difluoride-ethylene-tetrafluoroethylene copolymer, or the like. A porosity of the separator 3 may be, e.g., the porosity of the separator of a conventional rechargeable lithium ion battery.

The separator 3 may further include a surface layer covering the surface of the porous film or non-woven fabric described above. The surface layer may include an adhesive for immobilizing the battery element by adhering to the electrode. Examples of the adhesive may include, e.g., at least one of a vinylidene fluoride-hexafluoropropylene copolymer, an acid-modified product of vinylidene fluoride polymers, and a styrene-(meth)acrylic acid ester copolymer.

### 1-4. Non-Aqueous Electrolyte

As the non-aqueous electrolyte 4, the same non-aqueous electrolyte that is typically used for rechargeable lithium ion batteries may be used. The non-aqueous electrolyte 4 has a composition in which an electrolyte salt is included in a non-aqueous solvent, the non-aqueous solvent being a solvent for the electrolyte. Examples of the non-aqueous solvent may include cyclic carbonate esters such as, e.g., at least one of propylene carbonate, ethylene carbonate, butylene carbonate, chloroethylene carbonate, fluoroethylene carbonate, and vinylene carbonate, cyclic esters such as γ-butyrolactone and γ-valerolactone, chain carbonates such as, e.g., at least one of dimethyl carbonate, diethyl carbonate, or ethylmethyl carbonate, chain esters such as methylformate, methylacetate, methylbutyrate, ethyl propionate, propyl propionate, ethers such as tetrahydrofuran or a derivative thereof, 1,3-dioxane, 1,4-dioxane, 1,2-dimethoxyethane, 1,4-dibutoxyethane, or methyldiglyme, ethylene glycol monopropyl ether, or propylene glycol monopropyl ether, nitriles such as acetonitrile and benzonitrile, dioxolane or a derivative thereof, ethylene sulfide, sulfolane, sultone, or a derivative thereof, which may be used alone or in a mixture of two or more. On the other hand, when two or more types of non-aqueous solvents are mixed and used, a mixing ratio of each non-aqueous solvent may be a mixing ratio that may be used in a conventional or other rechargeable lithium ion battery.

Examples of the electrolyte salt may include an inorganic ion salt including, e.g., at least one of lithium (Li), sodium (Na) or potassium (K) such as LiClO₄, LiBF₄, LiAsF₆, LiPF₆, LiPF₆₋ₓ(CₙF₂ₙ₊₁)ₓ [provided that 1<x<6 and n=1 or 2], LiSCN, LiBr, LiI, Li₂SO₄, Li₂B₁₀Cl₁₀, NaClO₄, Nal, NaSCN, NaBr, KClO₄, KSCN, Nal, NaSCN, NaBr, KClO₄, KSCN, or an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, stearyl lithium sulfonate, octyl lithium sulfonate), dodecylbenzene lithium sulfonate, and the like, and it is also possible to use these ionic compounds alone or in a mixture of two or more types. Meanwhile, a concentration of the electrolyte salt may be the same as the concentration of a non-aqueous electrolyte used in a conventional rechargeable lithium ion battery. In some example embodiments, it is desirable to use a non-aqueous electrolyte 4 including the aforementioned lithium compound (electrolytic salt) at a concentration of greater than or equal to about 0.8 mol/L and less than or equal to about 1.5 mol/L.

Meanwhile, various additives may be added to the non-aqueous electrolyte 4. Examples of such additives may include, e.g., at least one of negative electrode-acting action additives, positive electrode-acting additives, ester additives, carbonate ester additives, sulfuric acid ester additives, phosphoric acid ester additives, boric acid ester additives, acid anhydride additives, and electrolyte additives. One of these may be added to the non-aqueous electrolyte, and a plurality of types of additives may be added.

### 2. Configuration of Non-aqueous Electrolyte Rechargeable Battery According to an Example Embodiment

Hereinafter, the characteristic configuration of the non-aqueous electrolyte rechargeable battery 100 according to some example embodiments will be described.

The positive electrode 1 of the non-aqueous electrolyte rechargeable battery 100 according to an example embodiment includes a positive electrode active material and inorganic particles for a non-aqueous electrolyte rechargeable battery (hereinafter also simply referred to as inorganic particles). In this example embodiment, the positive electrode 1 includes the positive electrode current collector 11 and the positive electrode mixture layer 12, as described above, and the positive electrode mixture layer 12 includes the positive electrode active material and the inorganic particles described above. The inorganic particles may be configured to operate as a heat suppressing additive that suppresses an increase in the internal temperature of the non-aqueous electrolyte rechargeable battery 100.

The particle diameter of the inorganic particles may be such that the integrated value of 50% (D₅₀) of the volume-based particle size distribution may be greater than or equal to about 0.3 μm and less than or equal to about 8.0 μm.

The shape of the inorganic particles may be spherical, flake-shaped, column-shaped, or needle-shaped, but may be desirably flake-shaped.

The aspect ratio (major/minor diameter) of the inorganic particles is greater than or equal to about 3.0 and less than or equal to about 30. The aspect ratio may be desirably greater than or equal to about 3.0 and less than or equal to about 20, and more desirably greater than or equal to about 3.0 and less than or equal to about 10. As described herein, the major diameter is the largest diameter of the particles, and the minor diameter is the smallest diameter of the particles. For example, the particles are in the form of flakes, wherein the major diameter may refer to the longest diameter of the flakes, while the minor diameter may refer to a thickness of the flakes.

A method of measuring the major diameter and the minor diameter may be, for example, a method of calculating D₅₀, which is 50% of an integrated value of a particle diameter volume-based particle size distribution obtained in a laser diffraction/scattering method or a method of calculating the major diameter and/or the minor diameter from a scanning electron microscope image. One of the above measuring methods alone may be used, or both of them may be used to adopt a more accurate method. For example, when the particles are flake-shaped and too thin to precisely measure a thickness in the method of calculating D₅₀, the major diameter may be measured by the aforementioned D₅₀, while the minor diameter may be obtained from the scanning electron microscope image.

A ratio B/A of D₅₀ (B) of the inorganic particles to D₅₀ (A), which is 50% of the volume-based particle size distribution of the positive electrode active material contained in the positive electrode mixture layer may be desirably greater than or equal to about 0.010 and less than or equal to about 0.8, more desirably greater than or equal to about 0.010 and less than or equal to about 0.6, still more desirably greater than or equal to about 0.010 and less than or equal to about 0.4, or much more desirably greater than or equal to about 0.010 and less than or equal to about 0.2.

The inorganic particles may contain, e.g., boron, or may include, e.g., at least one of boron nitride and zirconium boride, and more desirably, boron nitride (BN).

The inorganic particles may have a BET specific surface area, which is calculated by an adsorption isotherm measured by adsorbing nitrogen to the inorganic particles, desirably of greater than or equal to about 1 m²/g and less than or equal to about 50 m²/g, more desirably greater than or equal to about 5 m²/g and less than or equal to about 48 m²/g, or much more desirably greater than or equal to about 10 m²/g and less than or equal to about 48 m²/g.

A content of the inorganic particles contained in the positive electrode mixture layer may be desirably greater than or equal to about 0.1 wt % and less than or equal to about 5.0 wt %, more desirably greater than or equal to about 0.3 wt % and less than or equal to about 3.0 wt %, or much more desirably greater than or equal to about 0.5 wt % and less than or equal to about 2.0 wt %.

### 3. Manufacturing Method of Non-Aqueous Electrolyte Rechargeable Battery According to an Example Embodiment

Hereinafter, the manufacturing method of the non-aqueous electrolyte rechargeable battery 100 according to the present example embodiment is described.

### (3-1. Manufacturing Method of Positive Electrode)

The positive electrode 1 is manufactured as follows. First, a positive electrode slurry is formed by dispersing a mixture of a positive electrode active material, a conductive agent, a positive electrode binder, and inorganic particles in a desired ratio in a solvent for a positive electrode slurry. Next, this positive electrode slurry is coated on the positive electrode current collector 11 and dried to form a positive electrode mixture layer 12. On the other hand, the coating method may include, e.g., a knife coater method, a gravure coater method, a reverse roll coater, a slit die coater, and the like. Each, or one or more, of the following coating processes may also be performed by the same method. Subsequently, the positive electrode material mixture layer 12 is pressed by a press machine to have a desired density. Thus, a positive electrode 1 is manufactured.

### 3-2. Manufacturing Method of Negative Electrode

The negative electrode 2 may also be produced similarly to the positive electrode 1. First, a negative electrode slurry is prepared by dispersing a mixture of materials constituting the negative electrode mixture layer 22 in a solvent for a negative electrode slurry. Subsequently, a negative electrode mixture layer 22 is formed by coating the negative electrode slurry on the negative current collector 21 and drying it. Then, the negative electrode material mixture layer 22 is pressed by a press machine so as to have a desired density. Thus, a negative electrode 2 is manufactured.

### 3-3. Manufacturing Method of Non-Aqueous Electrolyte Rechargeable Battery

Next, an electrode structure is manufactured by placing a separator 3 between the positive electrode 1 and the negative electrode 2. Then, the electrode structure may be processed into a desired shape (e.g., cylindrical shape, prismatic shape, laminated shape, button shape, etc.) and inserted into a container of the above shape. Subsequently, a non-aqueous electrolyte is inserted into the corresponding container to impregnate the electrolyte solution 4 into each pore in the separator or a gap between the positive electrode 1 and negative electrode 2. Accordingly, a rechargeable lithium ion battery is manufactured.

### 4. Effect by the Example Embodiment

According to the non-aqueous electrolyte rechargeable battery 100 illustrated in FIG. 1 and configured as described above, even in an environment where the internal temperature is likely to rise due to battery abnormalities such as internal short circuits, the increase in the internal temperature of the non-aqueous electrolyte rechargeable battery 100 may be sufficiently reduced or suppressed, and additionally, the electrical resistance of the non-aqueous electrolyte rechargeable battery 100 can be reduced to a small resistance, thereby improving cycle characteristics of the non-aqueous electrolyte rechargeable battery 100.

### 5. Another Example Embodiment

The present disclosure is not limited to the aforementioned example embodiments.

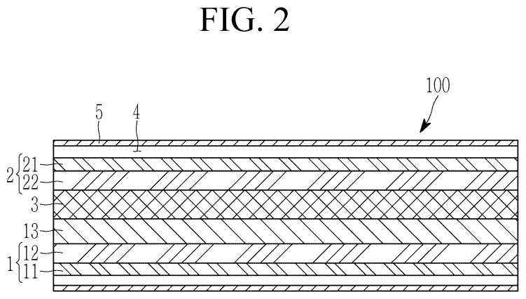

As shown in FIG. 2, which is a schematic cross-sectional view showing a cross-section view of the non-aqueous electrolyte rechargeable battery 100, the positive electrode 1 of the non-aqueous electrolyte rechargeable battery 100 according to an example embodiment may additionally have a temperature increase suppression layer 13 stacked on the surface opposite to the positive electrode current collector 11 from the positive electrode mixture layer 12.

The temperature increase suppression layer 13 may include, for example, a binder for binding the inorganic particles to each other, and for binding the temperature increase suppression layer 13 to the positive electrode mixture layer 12.

A content of the inorganic particles in the temperature increase suppression layer 13 may be desirably greater than or equal to about 40 wt % and less than or equal to about 99 wt %, more desirably greater than or equal to about 60 wt % and less than or equal to about 99 wt %, or much more desirably greater than or equal to about 80 wt % and less than or equal to about 99 wt % based on a total content (100 wt %) of the temperature increase suppression layer 13.

In the positive electrode mixture layer 12 or the temperature increase suppression layer 13, a content of the inorganic particles may be measured in the following method.

First, a cross-section sample containing the positive electrode mixture layer 12 alone or the temperature increase suppression layer 13 alone is prepared by using a cross-section sample preparation device such as a cross-section polisher and the like. The prepared cross-section sample is observed at least at three locations including the center and both ends thereof through SEM-EDS (Scanning Electron Microscopy—Energy Dispersive Spectroscopy) to quantitatively analyze a mass of boron contained in the cross-section sample. The SEM-EDS observation results are used to specify a molecular structure of the inorganic particles. The specified molecular structure of the inorganic particles and the mass of boron are used to calculate a mass of the inorganic particles included in the cross-section sample. This calculated mass of the inorganic particles may be used with a mass of the cross-section sample to calculate a content of the inorganic particles in the positive electrode mixture layer 12 or the temperature increase suppression layer 13.

The equipment and conditions used for measurement may be as follows.
Measuring apparatus: An electric field emission scanning electron microscope device SM-7800F (FE-SEM, JEOL Ltd.)
Energy dispersive analyzer JED100 mm (EDS, manufactured by Japan Electronics)
Acceleration voltage: 4 kV

The binder may be, for example, a binder for a positive electrode.

In the temperature increase suppression layer 13, a content of the binder may be, in terms of sufficiently reducing or suppressing an increase in an internal temperature, while demonstrating a sufficient binding force, desirably greater than or equal to about 1 wt % and less than or equal to about 99 wt %, more desirably greater than or equal to about 1 wt % and less than or equal to about 50 wt %, or much more desirably greater than or equal to about 1 wt % and less than or equal to about 30 wt % based on a total content (100 wt %) of the temperature increase suppression layer 13.

The temperature increase suppression layer 13 may have a thickness that is greater than or equal to about 0.1 μm and less than or equal to about 5 μm. The temperature increase suppression layer 13 may be adjusted to have a thickness that is greater than or equal to about 0.1 μm to secure a sufficient effect of suppressing exothermicity. In addition, the temperature increase suppression layer 13 may be adjusted to have a thickness that is less than or equal to about 5 μm to secure an effect of reducing or suppressing an increase in electrical resistance and a decrease in energy density of the battery by providing the temperature increase suppression layer 13. The temperature increase suppression layer 13 may have a thickness that is desirably greater than or equal to about 0.5 μm and less than or equal to about 5 μm or more desirably, greater than or equal to about 1 μm and less than or equal to about 4 μm. The thickness of the temperature increase suppression layer 13 may be measured, for example, in the following procedure. First, the positive electrode 1 is cut along a thickness direction to prepare a cross-section sample by using a cross polisher and the like. The prepared cross-section sample is examined with a scanning electron microscope (SEM) to take an SEM image, which is used to calculate the thickness of the temperature increase suppression layer 13. Specifically, in the cross-section sample, the thickness of the temperature increase suppression layer 13 is measured at least at three points including the center and both ends thereof, which are averaged to obtain the thickness of the temperature increase suppression layer 13.

After setting the content of the inorganic particles in the temperature increase suppression layer 13 within the desirable range, and setting the thickness of the temperature increase suppression layer 13 within the above range, the content of the inorganic particles may be adjusted within the same desirable range as the content of the inorganic particles in the positive electrode mixture layer 12 (i.e., greater than or equal to about 0.1 wt % and less than or equal to about 5.0 wt %, desirably greater than or equal to about 0.3 wt % and less than or equal to about 3.0 wt %, or more desirably greater than or equal to about 0.5 wt % and less than or equal to about 2.0 wt % based on a total content of the positive electrode mixture layer 12).

When a positive electrode has the temperature increase suppression layer 13, in the aforementioned method of manufacturing a positive electrode, after forming the positive electrode mixture layer including no or substantially no inorganic particles on the positive electrode current collector, temperature increase suppression layer slurry including the inorganic particles, a binder, and an appropriate solvent may be coated and dried on this positive electrode mixture layer to form the temperature increase suppression layer 13.

In addition, the present disclosure is not limited to these example embodiments but may be variously modified without deviating from the purpose.

### EXAMPLES

Hereinafter, the present disclosure will be described in more detail according to the following examples. However, the following examples are only one example of the present disclosure, and the present disclosure is not limited to the following examples.

### Manufacturing of Positive Electrode

### Example 1

LiCoO₂ (D50: 17 μm), acetylene black, polyvinylidene fluoride, and boron nitride A (Product number: BN—UHP, Resonac Corporation) as inorganic particles having properties shown in Table 1 in a solid content mass ratio of 96.7:1.0:1.3:1.0 were dispersed and mixed in an N-methyl-2-pyrrolidone solvent to prepare positive electrode mixture slurry. Subsequently, the positive electrode mixture slurry was applied to one side or both sides of an aluminum current collector foil to have a mixture coating amount (surface density) of 20.20 mg/cm² after drying and then, pressed with a roll press to form a mixture layer with density of 4.15 g/cc, manufacturing a positive electrode.

### Examples 2 to 7 and Comparative Examples 2 to 8

Each positive electrode of Examples 2 to 7 and Comparative Examples 6 to 7 was manufactured in the same procedure as in Experimental Example 1 with a difference that boron nitride B—I with properties shown in Table 1 was used as the inorganic particles. Each positive electrode of Comparative Examples 2 to 5 and 8 was manufactured in the same procedure as in Experimental Example 1 with a difference that aluminum diboride AlB₂, magnesium diboride MgB₂, titanium diboride TiB₂, niobium diboride NbB₂, and aluminum hydroxide with properties shown in Table 1 were respectively used as the inorganic particles.

### Example 8

A positive electrode mixture slurry was prepared by dispersing and mixing LiCoO₂ (D50: 17 μm), acetylene black, polyvinylidene fluoride, and boron nitride A with properties shown in Table 1 as inorganic particles in a solid content mass ratio of 97.2:1.0:1.3:0.5 in an N-methyl-2-pyrrolidone solvent. Subsequently, the positive electrode mixture slurry was applied to one side or both sides of an aluminum current collector foil to have a mixture coating amount (surface density) of 20.10 mg/cm² after drying and then, pressed with a roll press to form a mixture layer with density of 4.15 g/cc, manufacturing a positive electrode.

### Example 9

A positive electrode mixture slurry was prepared by dispersing and mixing LiCoO₂ (D50: 17 μm), acetylene black, polyvinylidene fluoride, and boron nitride A with properties shown in Table 1 as inorganic particles in a solid content mass ratio of 95.7:1.0:1.3:2.0 in an N-methyl-2-pyrrolidone solvent. Subsequently, the positive electrode mixture slurry was applied to one side or both sides of an aluminum current collector foil to have a mixture coating amount (surface density) of 20.10 mg/cm² after drying and then, pressed with a roll press to form a mixture layer with density of 4.15 g/cc, manufacturing a positive electrode.

### Examples 10 to 12 and Comparative Examples 1, and 9 to 10

A positive electrode mixture slurry was prepared by dispersing and mixing LiCoO₂, acetylene black, and polyvinylidene fluoride in a dry powder (solid content) mass ratio of 97.7:1.0:1.3 in an N-methyl-2-pyrrolidone solvent. Subsequently, the positive electrode mixture slurry was applied to one side or both sides of an aluminum current collector foil to have a mixture coating amount (surface density) of 20.0 mg/cm² after drying and then, pressed with a roll press to form a mixture layer with density of 4.15 g/cc, manufacturing a positive electrode.

In Examples 10 to 12 and Comparative Examples 9 and 10, each mixture slurry for a temperature increase suppression layer was prepared by dispersing and mixing inorganic particles (boron nitride A, B, D, H, I) shown in Table 1 and polyvinylidene fluoride as a binder in an N-methyl-2-pyrrolidone solvent. The inorganic particles and the binder were mixed in a mass ratio of X:100−X (X is a mass ratio, that is, wt % of inorganic particles described in Table 1 in the temperature increase suppression layer). This mixture slurry for a temperature increase suppression layer was applied to form a temperature increase suppression layer with a thickness shown in Table 1 on the opposite side of the positive electrode mixture layer to the positive electrode current collector and dried at a temperature of 100° C. for 600 seconds. In Examples 10 to 12 Comparative Examples 9 and 10, a content of the inorganic particles in each temperature increase suppression layer was adjusted to 1 wt % based on a total amount of the positive electrode mixture layer. The coating thickness of the mixture slurry for a temperature increase suppression layer was measured in the following method. Positive Electrode 1 was measured with respect to average thicknesses before and after coating the mixture slurry for a temperature increase suppression layer by using a static pressure thickness meter (Teclock Measurement DX). Subsequently, a difference of the average thicknesses of the positive electrode before and after the coating was calculated and then, used as the coating thickness of the mixture slurry for a temperature increase suppression layer. Because this coating thickness is not changed in the subsequent drying process, this coating thickness may be used as a thickness of the temperature increase suppression layer.

### <Manufacturing of Negative Electrode>

### Examples 1 to 12 and Comparative Examples 1 to 10

A negative electrode mixture slurry was prepared by dispersing and mixing artificial graphite, carboxylmethyl cellulose sodium salt (CMC), styrene butadiene-based water dispersion in a dry powder (solid content) mass ratio of 97.5:1.0:1.5 in a water solvent. Subsequently, the positive electrode mixture slurry was applied to one side or both sides of a copper foil as a negative current collector to have a mixture coating amount (surface density) of 15.0 mg/cm² after drying and then, pressed with a roll press to form a mixture layer with density of 1.65 g/cc, manufacturing a positive electrode.

### Manufacture of Rechargeable Battery Cells

### Examples 1 to 12 and Comparative Examples 1 to 10

A plurality of the positive electrodes and a plurality of the negative electrode were stacked with a polypropylene porous separator between the positive and negative electrodes to have battery design capacity of 300 mAh, manufacturing an electrode stack. At this time, as the positive electrode and negative electrode are placed inside the electrode stack, mixture layers formed on both surfaces of the current collector were used, and for the positive electrode or negative electrode disposed on the outermost layer, a mixture layer formed on only one surface was used. For example, a positive electrode with an electrode plate area of 8.5 cm² (both surfaces, 5 sheets) and a negative electrode with an electrode plate area of 10.0 cm² (4 sheets of both surfaces and 2 sheets of one surface) were manufactured. Subsequently, a rechargeable battery cell before the initial charge was manufactured by welding nickel and aluminum lead wires respectively to the negative and positive electrodes of the electrode stack, housing the electrode stack in an aluminum laminate film with the lead wires externally pulled out, injecting an electrolyte solution thereinto, and sealing the aluminum laminate film under a reduced pressure. The electrolyte solution was prepared by dissolving 1.3 M LiPF₆ and 1 wt % of vinylene carbonate in a mixed solvent of ethylene carbonate/dimethyl carbonate/fluoroethylene carbonate in a volume ratio of 15/80/5.

### Evaluation of Inorganic Particles

The inorganic particles used in the examples and comparative examples were evaluated as follows.

### Specific Surface Area

The specific surface area (BET specific surface area calculated based on the adsorption isotherm measured by adsorbing water vapor) of the inorganic particles was measured using a gas adsorption amount measuring device (Microtrack, BELSORP), according to JIS K6217-2.

### Evaluation of Particle Diameter

The particle diameters of the inorganic particles and positive electrode active material were evaluated as D50, 50% of an integrated value of a particle diameter volume-based particle size distribution in a particle size distribution obtained by a laser diffraction/scattering method. D₅₀(A) of the positive electrode active material and D₅₀(B) of the inorganic particles were measured using the following equipment and conditions, and the ratios B/A of the particle diameters of the inorganic particles and the positive electrode active material were also calculated from the values A and B.
Measuring device: Laser diffraction/scattering particle diameter distribution measuring device MT3300 (manufactured by Micro Track Bell)
Permeability: Permeable
Shape: Non-spherical
Circulation speed: 7
Measurement time: 30 seconds
Number of repetitions: 3
Complex refractive index:
a. inorganic particle: 1.65-0.00i
b. ethanol solvent: 1.36-0.00i
c. positive electrode active material: 2.09-0.00i

### Measurement of the Ratio of the Major Axis and Minor Axis of Inorganic Particles

An average particle diameter (D₅₀) obtained by the laser diffraction/scattering method was taken as the major diameter of the inorganic particles. After attaching the inorganic particles onto a carbon tape, a scanning electron microscope JSM-7800F (JEOL Ltd.) was used to obtain a scanning electron microscope image of the inorganic particles. Among the inorganic particles included in the obtained scanning electron microscope image, any 100 particles imaged in a perpendicular direction to the thickness direction were taken to measure thicknesses, of which arithmetic average was obtained as the minor diameter of the inorganic particles.

The major diameter and the minor diameter obtained in the above method were used to obtain a ratio of the major diameter and the minor diameter (major/minor diameter), that is, an aspect ratio.

### Evaluation of Rechargeable Battery Cells

### Cycle Characteristics

The rechargeable battery cells according to Examples 1 to 12 and Comparative Examples 1 to 10 were charged under a constant current to 4.3 V at 0.1 CA (capacity in ampere-hour) of design capacity and charged under a constant voltage to 0.05 CA still at 4.3 V in a 25° C. thermostat. Subsequently, the cells were discharged under a constant current to 3.0 V at 0.1 CA. In addition, the cells were measured with respect to initial discharge capacity after the 1^{st} cycle through a constant current charge at 0.2 CA, a constant voltage charge at 0.05 CA, and a constant current discharge at 0.2 CA under conditions of a charge cut-off voltage of 4.3 V and a discharge cut-off voltage of 3.0 V in the 25° C. thermostat. The rechargeable battery cells were 100 cycles charged and discharged through a constant current charge at 0.5 CA, a constant voltage charge at 0.05 CA, and a constant current discharge 0.5 CA under conditions of a charge cut-off voltage of 4.3 V and a discharge cut-off voltage of 3.0 V at 45° C. to test a cycle-life. After the 100 cycles, discharge capacity at a constant current charge of 0.2 CA, a constant voltage charge of 0.05 CA, and a discharge at 0.2 CA of the cells was measured and was divided by the initial discharge capacity to obtain capacity retention after the 100 cycles.

### Heating Test

The rechargeable battery cells according to Examples 1 to 12 and Comparative Examples 1 to 10 were charged under a constant current to 4.42 V at design capacity of 0.1 CA and charged under a constant voltage at 4.42 V to 0.05 CA in the 25° C. thermostat. Subsequently, the cells were discharged to 3.0 V at 0.1 CA under a constant current. In addition, in the 25° C. thermostat, after performing a constant current charge at 0.2 CA, a constant voltage charge at 0.05 CA, and a constant current discharge at 0.2 CA under conditions of a charge cut-off voltage of 4.42 V and a discharge cut-off voltage of 3.0 V as 1 cycle, the cells were charged again under a constant current/constant voltage to 4.42 V, which were regarded as initial cells. These initial cells were left for 1 hour in a thermostat heated to 165° C., and a case where a voltage of a battery cell became 4.2 V or less was regarded as “abnormal occurrence,” and an abnormal occurrence rate was evaluated in the 10 battery tests.

### Nail Penetration Test

A nail penetration test was conducted by penetrating the aforementioned initial cells in the center with a nail having a diameter of 3 mm at 1 mm/s. A case where an external temperature of a battery cell reached 50° C. or higher 5 seconds after penetrated with the nail was regarded as “abnormal occurrence,” and an abnormal occurrence rate was evaluated in the 10 battery tests.

### Overcharge Test

When the external temperature of a battery cell reached 50° C. or higher after additionally charging the aforementioned initial cells under a constant current to 12 V at 3 CA, charging the initial cells under a constant voltage for 10 minutes after reaching 12 V was regarded as “abnormal occurrence,” an abnormal occurrence rate was evaluated in the 10 battery tests.

### Evaluation of Cell Resistance (Ω)

The initial cells were fully charged and measured with respect to cell resistance (Ω) in an AC impedance (EIS) method at 25° C. The measurement was performed within a frequency range of 100 kHz to 100 mHz by applying a voltage of 10 mV. In addition, in this EIS method, VMP-3 Potentiostat manufactured by BioLogic was used as a measuring apparatus. Herein, a size of a semicircular arc of a Nyquist plot obtained from the measurement was taken as the cell resistance.

### Evaluation Results

The types and physical properties of the inorganic particles used in the examples and comparative examples described above are shown in Table 1. In addition, the evaluation results for the rechargeable battery cells of Examples 1 to 12 and Comparative Examples 1 to 10 are summarized in Table 2.

TABLE 1

| | | | | | | | | Ratio of | |
|---|---|---|---|---|---|---|---|---|---|
| | | | | | | | | inorganic | |
| | | | | | | | | particles in | Thickness of |
| | | | | | | Particle | | temperature | temperature |
| | | Content of | | Ratio of the | BET | diameter | Place where | increase | increase |
| | | inorganic | Particle | major axis and | specific | 2/Particle | inorganic | suppression | suppression |
| | | particles | diameter | minor axis | surface area | diameter 1 | particles are | layer (X) | layer |
| | Inorganic particle | (wt %) | D₅₀ (μm) | — | (m²/g) | — | included | (%) | (μm) |
| Ex. 1 | boron nitride A | 1.0 | 0.7 | 4.3 | 10.8 | 0.041 | positive | — | — |
| Ex. 2 | boron nitride B | 1.0 | 6.0 | 27.3 | 6.6 | 0.353 | electrode | | |
| Ex. 3 | boron nitride C | 1.0 | 1.0 | 5.3 | 25.8 | 0.059 | mixture | | |
| Ex. 4 | boron nitride D | 1.0 | 3.2 | 14.2 | 24.1 | 0.188 | layer | | |
| Ex. 5 | boron nitride E | 1.0 | 0.5 | 4.2 | 41.2 | 0.029 | | | |
| Ex. 6 | boron nitride F | 1.0 | 0.3 | 3.2 | 47.4 | 0.018 | | | |
| Ex. 7 | boron nitride G | 1.0 | 8.0 | 29.1 | 5.9 | 0.471 | | | |
| Ex. 8 | boron nitride A | 0.5 | 0.7 | 4.3 | 10.8 | 0.041 | | | |
| Ex. 9 | boron nitride A | 2.0 | 0.7 | 4.3 | 10.8 | 0.041 | | | |
| Ex. 10 | boron nitride A | 1.0 | 0.7 | 4.3 | 10.8 | 0.041 | temperature | 85 | 4 |
| Ex. 11 | boron nitride B | 1.0 | 6.0 | 27.3 | 6.6 | 0.353 | increase | 95 | 2 |
| Ex. 12 | boron nitride D | 1.0 | 3.2 | 14.2 | 24.1 | 0.188 | suppression | 90 | 3 |
| | | | | | | | layer | | |
| Comp. Ex. 1 | No addition | | | | | | | | |
| Comp. Ex. 2 | aluminum diboride | 1.0 | 2.2 | 0.8 | 20.2 | 0.129 | positive | — | — |
| Comp. Ex. 3 | magnesium diboride | 1.0 | 6.5 | 0.9 | 11.5 | 0.382 | electrode | | |
| Comp. Ex. 4 | titanium diboride | 1.0 | 3.1 | 0.8 | 22.1 | 0.182 | mixture | | |
| Comp. Ex. 5 | niobium diboride | 1.0 | 2.5 | 0.9 | 19.5 | 0.147 | layer | | |
| Comp. Ex. 6 | boron nitride H | 1.0 | 11.0 | 32.1 | 5.7 | 0.647 | | | |
| Comp. Ex. 7 | boron nitride I | 1.0 | 0.1 | 2.5 | 50.1 | 0.006 | | | |
| Comp. Ex. 8 | aluminum hydroxide | 1.0 | 3.0 | 0.8 | 12.5 | 0.176 | | | |
| Comp. Ex. 9 | boron nitride H | 1.0 | 11.0 | 32.1 | 5.7 | 0.647 | temperature | 95 | 3 |
| Comp. Ex. 10 | boron nitride I | 1.0 | 0.1 | 2.5 | 50.1 | 0.006 | increase | 80 | 3 |
| | | | | | | | suppression | | |
| | | | | | | | layer | | |

TABLE 2

| | | Discharge | | Nail | Over- |
|---|---|---|---|---|---|
| | | capacity | Heating | penetration | charge |
| | Cell | retention | test | test | test |
| | resis- | rate after | abnormal | abnormal | abnormal |
| | tance | 100 cycles | occurrence | occurrence | occurrence |
| | (Ω) | (%) | (%) | (%) | (%) |
| Ex. 1 | 1.5 | 90.2 | 0 | 10 | 0 |
| Ex. 2 | 1.4 | 90.3 | 0 | 10 | 10 |
| Ex. 3 | 1.5 | 90.2 | 0 | 10 | 0 |
| Ex. 4 | 1.5 | 90.2 | 0 | 10 | 10 |
| Ex. 5 | 1.5 | 90.3 | 0 | 0 | 10 |
| Ex. 6 | 1.5 | 90.2 | 0 | 0 | 0 |
| Ex. 7 | 1.3 | 90.3 | 0 | 10 | 10 |
| Ex. 8 | 1.5 | 90.2 | 30 | 20 | 20 |
| Ex. 9 | 1.6 | 90.1 | 0 | 0 | 0 |
| Ex. 10 | 1.5 | 90.2 | 0 | 0 | 0 |
| Ex. 11 | 1.3 | 90.3 | 0 | 10 | 10 |
| Ex. 12 | 1.4 | 90.2 | 0 | 10 | 0 |
| Comp. Ex. 1 | 1.5 | 90.2 | 100 | 100 | 100 |
| Comp. Ex. 2 | 2.0 | 84.2 | 0 | 20 | 20 |
| Comp. Ex. 3 | 1.9 | 85.1 | 0 | 20 | 20 |
| Comp. Ex. 4 | 2.1 | 83.8 | 40 | 60 | 50 |
| Comp. Ex. 5 | 1.9 | 85.5 | 60 | 80 | 60 |
| Comp. Ex. 6 | 1.8 | 87.2 | 10 | 20 | 20 |
| Comp. Ex. 7 | 1.7 | 87.9 | 0 | 10 | 20 |
| Comp. Ex. 8 | 1.8 | 87.3 | 90 | 90 | 90 |
| Comp. Ex. 9 | 1.7 | 88.2 | 10 | 10 | 10 |
| Comp. Ex. 10 | 1.7 | 88.0 | 0 | 10 | 20 |

### Confirmation of Exothermic Behavior Under Coexistence of Charged Positive Electrode and Electrolyte Solution

The initial cells of the fully charged rechargeable battery cells manufactured in Example 1 and Comparative Example 1 shown in Table 1 and Table 2 were disassembled in a glove box, and the positive electrodes were washed with dimethyl carbonate solvent and dried, and the obtained positive electrodes were used as a “charged positive electrode.”

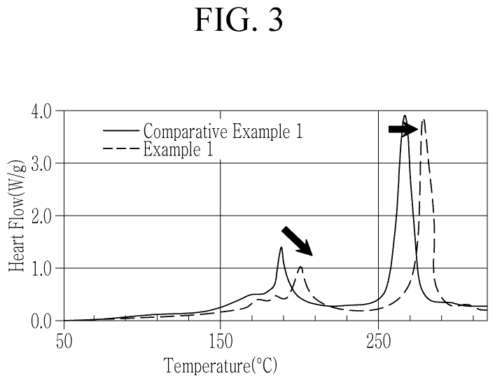

2.0 mg of the “charged positive electrode” and 1.0 mg of the same electrolyte used when manufacturing the rechargeable battery cell were placed in a special airtight container, caulked, and then using a differential scanning calorimetry device, DSC (differential scanning calorimetry) (manufactured by Hitachi High-Tech Science), the temperature was raised at a temperature increase rate of 5 K/min in accordance with the provisions of JISK7121, and the exothermic behavior was evaluated. The results are shown in FIG. 3. The solid line represents Comparative Example 1, and the broken line represents Example 1.

### Evaluation of Oxygen Capture Capacity

As described in Tables 1 and 2, after manufacturing the rechargeable battery cells according to Example 1 and Comparative Example 1, the initial cells, by fully charging the rechargeable battery cells, were disassembled in a glove box to remove the positive electrodes, which were washed with a dimethylcarbonate solvent and dried and subsequently subjected to “charged positive electrodes.” After placing 70.0 mg of each of the “charged positive electrodes” in a dedicated alumina pan and subsequently placing in a thermogravimetric-differential thermal analysis device (TG-DTA, Thermo plus EVO TG8120 manufactured by Rigaku Corp.), oxygen capture capacity was measured by increasing a temperature at 10 K/min under a Helium (He) atmosphere to measure oxygen gas (m/z=32) with a mass analysis device (GC-MS, GCMS QP 2010Plus manufactured by Shimadzu Corp.)

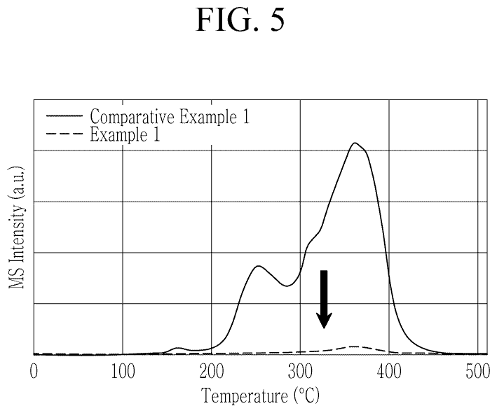

The results are shown in FIG. 5. The solid line represents Comparative Example 1, and the broken line represents Example 1.

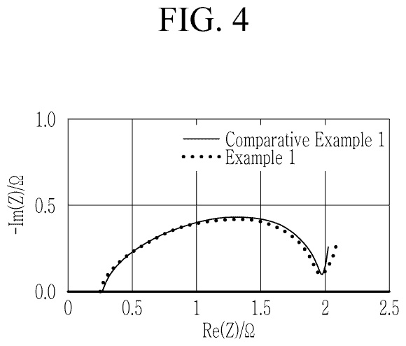

In addition, a graph of the cell resistance of the rechargeable battery cells of Example 1 and Comparative Example 1 is shown in FIG. 4. The solid line represents Comparative Example 1, and the broken line represents Example 1.

### Review on Examples and Comparative Examples

Referring to Table 2, Examples 1 to 12, compared with Comparative Example 1 having a positive electrode including no or substantially no inorganic particles, Comparative Examples 2 to 7, 9, and 10 having D₅₀ or an aspect ratio of the inorganic particles including boron out of the specified range, and Comparative Example 8 using inorganic particles containing no boron, turned out to sufficiently reduce or suppress an abnormality occurrence rate caused by an increase in an internal temperature of the cells even under conditions of easily increasing the internal temperature of the battery cells such as a high temperature, an external impact by nailing, and an overcharge. In FIG. 3, two peaks identified in the solid line graph showing exothermic behaviors of Comparative Example 1 were all shifted toward a high temperature in the solid line graph showing exothermic behaviors of Example 2, and the peaks were lowered, which confirmed that the increase in an internal temperature of the battery cells were reduced in the example. In non-aqueous electrolyte rechargeable batteries, it is known that oxygen generated by structural collapse of an active material when a temperature rises causes a decomposition reaction with an electrolyte solution or a conductive agent, which accelerates exothermicity. From the analysis results of the generated oxygen gas in Example 1 and Comparative Example 1, which were shown in FIG. 5, Example 1 exhibited that a released amount of the oxygen was significantly reduced, compared to Comparative Example 1. In this way, Example 1, in which oxygen was captured by the inorganic particles, was reduced from an exothermic reaction of the oxygen with an electrolyte solution and the like and thus expected to be reduced from an increase in an internal temperature of the battery cell.

In addition, referring to the results of Table 2 and FIG. 4, Examples 1 to 12 exhibited internal resistance of less than or equal to 1.6, which was almost equal to that of Comparative Example 1 including no inorganic particles, or some of the examples were rather lower than that of Comparative Example 1. In addition, referring to the results of Table 2, Examples 1 to 12 exhibited cycle characteristics that are greater than or equal to 90% and thus maintained almost equally sufficiently practical values to the cycle characteristics of Comparative Example 1.

From the above experiment results, the present disclosure, in which D₅₀ and an aspect ratio of the inorganic particles containing nitrogen atoms were designed within predetermined ranges, sufficiently reduced an increase in an internal temperature of the battery cells, reduced an increase in cell resistance or deterioration of cycle characteristics, and maintained battery performance within appropriate ranges.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the appended claims.

### DESCRIPTION OF SYMBOLS

100 . . . non-aqueous electrolyte rechargeable battery
1 . . . positive electrode
11 . . . positive electrode current collector
12 . . . positive electrode mixture layer
13 . . . temperature increase suppression layer
2 . . . negative electrode
21 . . . negative electrode current collector
22 . . . negative electrode mixture layer
3 . . . separator
4 . . . non-aqueous electrolyte
5 . . . container

What is claimed is:

1. A positive electrode for a non-aqueous electrolyte rechargeable battery, the positive electrode comprising:
a positive electrode active material and inorganic particles,
wherein the inorganic particles include boron,
D₅₀ is greater than or equal to about 0.3 μm and less than or equal to about 8.0 μm, where D₅₀ is 50% of an integrated value of a particle diameter volume-based particle size distribution in a particle size distribution obtained by a laser diffraction/scattering method of the inorganic particles, and
a ratio of a major diameter to a minor diameter of the inorganic particles is greater than or equal to about 3.0 and less than or equal to about 30.

2. The positive electrode as claimed in claim 1, wherein
a ratio B/A of D₅₀ (B)/D₅₀ (A) is greater than or equal to about 0.010 and less than or equal to about 0.8,
where D₅₀ (B) is 50% of an integrated value of a particle diameter volume-based particle size distribution in a particle size distribution obtained by a laser diffraction/scattering method of the inorganic particles, and
D₅₀ (A) is 50% of an integrated value of a particle diameter volume-based particle size distribution in a particle size distribution obtained by a laser diffraction/scattering method of the positive electrode active material.

3. The positive electrode as claimed in claim 1, wherein the inorganic particles comprise boron nitride (BN).

4. The positive electrode as claimed in claim 1, wherein a BET specific surface area of the inorganic particles is greater than or equal to about 1 m²/g and less than or equal to about 50 m²/g.

5. The positive electrode as claimed in claim 1, wherein:
the positive electrode includes a positive electrode current collector and a positive electrode mixture layer on the positive electrode current collector,
the positive electrode mixture layer includes inorganic particles, and
a content of the inorganic particles based on 100 wt % of the positive electrode mixture layer is greater than or equal to about 0.1 wt % and less than or equal to about 5.0 wt %.

6. The positive electrode as claimed in claim 1, wherein:
the positive electrode includes a positive electrode current collector, a positive electrode mixture layer on the positive electrode current collector, and a temperature increase suppression layer on a side of the positive electrode mixture layer opposite to the current collector,
the temperature increase suppression layer includes the inorganic particles,
a content of the inorganic particles based on 100 wt % of the temperature increase suppression layer is greater than or equal to about 40 wt % and less than or equal to about 99 wt %.

7. The positive electrode as claimed in claim 6, wherein the temperature increase suppression layer has a thickness that is greater than or equal to about 0.1 μm and less than or equal to about 5 μm.

8. A non-aqueous electrolyte rechargeable battery, comprising:
a positive electrode, a negative electrode, a separator, and a non-aqueous electrolyte,
wherein the positive electrode is the positive electrode as claimed in claim 1.
